(19) United States
(12) Patent Application Publication
(10) Pub. No.: US 2025/0386852 A1
(43) Pub. Date: Dec. 25, 2025

(54) A METHOD FOR MAKING A LAYER OF RECONSTITUTED MATERIAL OF PLANT ORIGIN

(71) Applicant: COMAS - COSTRUZIONI MACCHINE SPECIALI - S.P.A., Silea (Treviso) (IT)

(72) Inventors: Alessandro GRANZOTTO, Silea (Treviso) (IT); Fulvio PASTORE, Silea (Treviso) (IT)

(21) Appl. No.: 18/880,684

(22) PCT Filed: Jul. 5, 2023
(86) PCT No.: PCT/IB2023/056946

§ 371 Date: Jan. 2, 2025

(30) Foreign Application Priority Data
Jul. 6, 2022 (IT) 102022000014227

(51) Int. Cl. A24B 15/16; A24B 3/14; A24B 15/28; A24B 15/32

(52) U.S. Cl. CPC A24B 15/16; A24B 3/14; A24B 15/287; A24B 15/32

(57) ABSTRACT

A method for making a layer of reconstituted material of plant origin, including the steps of providing a starting material, constituted by solid components at a first temperature, and of dry grinding the solid components of the starting product to obtain a dry powdered product. Then, mixing the dry powdered product with one or more mixing liquids, having a second temperature greater than the first temperature, thereby obtaining a mix having a third temperature that is greater than or equal to an enzyme deactivation temperature of the starting material. The step of mixing is carried out in such a way that the third temperature is reached in a shorter time interval than a predetermined time interval. Then the mix is transferred onto a conveyor belt in the form of a continuous layer and is dried, thus obtaining a dry continuous layer.

### TECHNICAL FIELD

The present invention relates to a method for making a web of reconstituted material of plant origin, in particular for making traditional or HNB smoking articles. In particular, the method is applied on a material different from tobacco.

### BACKGROUND ART

Known in the prior art is the production of a web of tobacco reconstituted starting from a highly fluid mixture of tobacco with extremely fine particle size (“slurry”).

The application of such a method on plant materials different from tobacco has proven to be very complex and not very satisfactory since such materials, although cheap to use, contain substances susceptible to chemical-physical alterations during the process, in particular during heating, the consequence being an unwanted development of an unpleasant odour as well as an unpleasant aroma during consumption of the corresponding smoking article obtained from it.

### DISCLOSURE OF THE INVENTION

The technical aim of this invention is therefore to provide a method for making a web of reconstituted material of plant origin without the drawbacks of the prior art.

In particular, the aim of the invention is to provide a method for making a web of reconstituted material of plant origin which allows application on materials different from tobacco to obtain products with quality suitable for sale.

A further aim of the invention is to provide a method for making a reconstituted web of material of plant origin which requires a simple architecture for the plant necessary to implement it.

The aims specified are substantially achieved by a method in accordance with the features set out in claim 1 and/or in one or more of the claims dependent thereon.

### BRIEF DESCRIPTION OF DRAWINGS

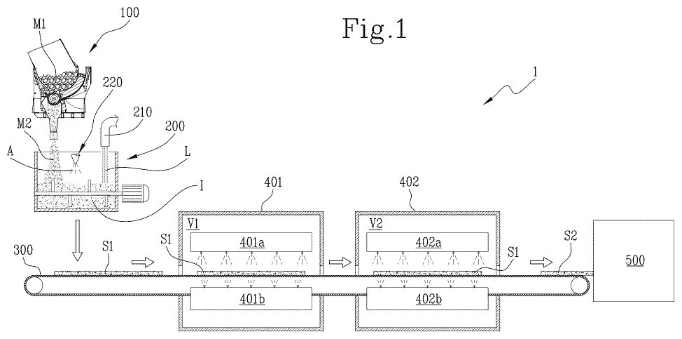

Further features and advantages of this invention will be more apparent in the exemplary, hence non-limiting description of a preferred, but non-exclusive, embodiment of a method for making a web of tobacco, as illustrated in FIG. 1, which shows a schematic view of an exemplary (hence non-limiting) embodiment of a plant for implementing a method in accordance with this invention.

### DETAILED DESCRIPTION OF PREFERRED EMBODIMENTS OF THE INVENTION

An embodiment of the method according to the invention will now be described with reference to the respective plant used to implement it, labelled 1 in FIG. 1.

In accordance with the invention, the method comprises a step of providing a first quantity of a starting material “M1” constituted by solid components and in particular, a plant fibre product at least partly, preferably entirely, different from tobacco.

In accordance with a first example, the starting material “M1” is rapeseed.

In accordance with a second example, the starting material “M1” is hay. The term “hay” refers to a plant aggregate comprising grass and fodder plants, that are cut and dried. Moreover, the term “grass” (or herbaceous plant) generically refers to plants with non-woody stems, which usually grow wild or are cultivated in fields.

In accordance with a third example, the starting material “M1” is straw. The term “straw” refers to a plant aggregate comprising stalks of cereal plants, such as wheat, oats, rice or barley, which are separated from the grains after harvesting, cut and dried.

However, it should be noticed that the same method according to the invention is implementable starting with a generic plant fibre product different from tobacco and an alternative to rapeseed, such as natural fibres, for example cellulose fibres.

There is also the possibility that the starting material might be formed by a mix of different plant fibre products which are different from tobacco.

The first quantity of the starting material “M1” is processed while it is at a first supply temperature. The first temperature is less than an enzyme activation temperature of the starting material “M1” used in the plant and is, preferably, equal to ambient temperature.

In this description, the expression “enzyme activation temperature” refers to the lower limit of the temperature range in which activation and development of the enzymes takes place. Activation of the enzymes is the (known) phenomenon which causes oxidative rancidity of the oils naturally contained in the starting material “M1” itself. In fact, such enzymes would lead to the formation of various types of chemical compounds, characterised by unpleasant odours and flavours, and therefore to the decay of the organoleptic properties of the material.

That temperature range is an intrinsic feature of the starting material “M1” used.

With reference to rapeseed, the above-mentioned temperature range is typically between 30° and 63°. Therefore, for rapeseed the enzyme activation temperature may be established at approximately 30°, above which development of the enzymes from the oils naturally contained in the starting material “M1” begins.

With reference to hay, the above-mentioned temperature range is typically between 33° and 60°. Therefore, for hay the enzyme activation temperature may be established at approximately 33°, above which development of the enzymes from the oils naturally contained in the starting material “M1” begins.

With reference to rapeseed 35° and 68°. Therefore, for rapeseed the enzyme activation temperature may be established at approximately 35°, above which development of the enzymes from the oils naturally contained in the starting material “M1” begins. Advantageously, keeping the first temperature below the enzyme activation temperature ensures that the starting material “M1” is substantially still free of such enzymes.

Then, the method comprises a step of grinding for dry grinding the solid components of the starting material “M1” to obtain a dry powdered product “M2” having a first particle size, preferably between 20 microns and 500 microns, more preferably between 70 microns and 250 microns. In other words, the solid particles of the dry powdered product “M2” obtained in this way, although having a wide range of particle size values, include particles with a maximum particle size of up to 500 microns, preferably up to 250 microns.

The term “particle size” refers to the size of the particles expressed in terms of diameter of the particles themselves. Moreover, it shall be understood that roughly all of the particles have a particle size within the above-mentioned ranges.

As shown in FIG. 1, for that purpose the plant 1 comprises a grinding unit 100 of the silo or hammer mill or pin mill type specifically provided with screens or other sifting means configured to allow only particles that are smaller than the predetermined size to pass through them.

The grinding unit 100 may be defined by a single stage or by multiple stages.

After the step of grinding there is a step of mixing to combine, and mix, the particles of the dry powdered product “M2” with a second quantity of one or more liquids “L” so as to obtain a mix “I”.

The one or more liquids “L” have a second temperature greater than the first supply temperature, so as to increase the temperature of the mix simultaneously with the increase in the level of the liquid component.

The one or more liquids “L” may be, for example, water and/or at least one binding agent (for example, cellulose-based) and/or an aerosol forming material and/or aromatizers.

The step of mixing is performed by a mixer 200 with known structure associated with at least one feeder 210 for adding the liquid component.

Preferably, the mixer 200 is configured to work on separate quantities of product. In other words, the mixer 200 is configured to supply discontinuous quantities of mix “I”, each deriving from a corresponding cycle of loading of the first quantity of the dry powdered product “M2” and of the second quantity of the one or more liquids “L”.

In accordance with the invention, the mix “I” obtained must have a third temperature that is greater than or equal to the enzyme deactivation temperature of the starting material “M1”.

In this description, the expression “enzyme deactivation temperature” refers to the upper limit of the temperature range in which activation and development of the enzymes takes place, being an intrinsic feature of the plant material used.

With reference to rapeseed, the enzyme deactivation temperature is approximately equal to 63° C., above which development of such enzymes ceases.

With reference to hay, the enzyme deactivation temperature is approximately equal to 60° C., above which development of such enzymes ceases.

With reference to straw, the enzyme deactivation temperature is approximately equal to 68° C., above which development of such enzymes ceases. According to one distinctive aspect of this invention, the step of mixing is carried out in such a way that the third temperature is reached in a shorter time interval than a predetermined time interval. In other words, the step of mixing is carried out in such a way that the mix crosses the above-mentioned temperature range (with reference to the specific starting material) in a shorter time interval than a predetermined time interval.

Therefore, it shall be understood that the temperature change of the step of mixing (in which the first quantity is heated by the second quantity) must be completed in the shortest possible time interval so that the enzymes contained in the starting material “M1”, are deactivated upon reaching the enzyme deactivation temperature.

For example, with reference to rapeseed, the enzymes are activated at around 30° C. and are deactivated at around 63° C., reaching peak activation at between 38° C. and 46° C.

Therefore, the third temperature must be reached in the shortest possible time interval, in a substantially instantaneous way in order to allow immediate enzyme deactivation. Preferably, the predetermined time interval is less than or equal to 15 seconds, irrespective of the type of starting material.

Therefore it is necessary to have a second temperature and/or a second quantity which are such that they allow the starting material “M1” (which has become a component of the mix “I”) to reach the enzyme deactivation temperature.

Preferably, for that purpose, the second temperature is greater than or equal to 70° C. Moreover, preferably, the second quantity is such that the mix “I” obtained in the step of mixing has a percentage by weight of liquid of between 30% and 70%.

Clearly, in order to reach the third temperature in a minimum time interval it is possible to increase the second quantity and the second temperature.

Preferably, the step of mixing is continued even after reaching the third temperature, in any case keeping the temperature of the mix “I” above the enzyme deactivation temperature.

In particular, because of evaporation of the one or more liquids “L” due to the operating temperatures inside the mixer 200, the mix tends to reduce the temperature. However, the mechanical work of mixing compensates for the thermal loss by keeping the mix “I” at a temperature greater than or equal to the enzyme deactivation temperature. Alternatively, in order to keep the temperature above the enzyme deactivation temperature, a mixer 200 equipped with heating means may be provided.

Preferably, after reaching the third temperature, the step of mixing is continued for between 5 minutes and 25 minutes.

Moreover, preferably, at least one deodorizing agent “A” may be added to the mix “I” after reaching the third temperature in the step of mixing.

The deodorizing agent “A” may be one or more of the following: vapour, in particular, water vapour, an inert gas, in particular, carbon dioxide and/or an apolar solvent, in particular, hexane.

For that purpose, the mixer 200 may comprise adding means 220 such as for example nozzles for supplying the above-mentioned deodorizing agents “A”.

According to one aspect of this invention, there may be a step of diluting the mix “I” with one or more dilution liquids, in particular, water, performed after or simultaneously with the step of mixing.

Preferably, after that step of diluting, the mix “I” has a percentage by weight of the one or more liquids “L”, in particular, water, of between 70% and 90%. Advantageously, dilution allows the mix “I” to have an optimum rheology so that it can be worked efficiently in the subsequent steps of the method, as will be more apparent in the description below.

As shown in FIG. 1, a conveyor belt 300 is disposed downstream of the mixer 200. In particular: the mixer 200 has supplying means, for example a screw feeder, configured to supply the mix “I” onto the processing belt so as to make a continuous layer “S1” of mix on the conveying surface of the conveyor belt 300.

Preferably, the continuous layer “S1” has a thickness of between 100 microns and 800 microns. Advantageously, a limited thickness allows homogeneous drying of the continuous layer “S1”.

The conveyor belt 300 is configured to feed the continuous layer “S1” through one or more drying spaces “V1”, “V2” disposed in series, wherein each drying space “V1”, “V2” is defined by a respective dryer 401, 402, so as to obtain a dry continuous layer “S2” having a desired percentage of liquid. The one or more drying spaces “V1”, “V2” define a drying path for the continuous layer “S1” so as to obtain the dry continuous layer “S2”. In functional terms, the dryers 401, 402 are configured to ensure that, at the end of the drying process, the dry continuous layer “S2” has a predetermined humidity value. In particular, at the end of the drying process, the dry continuous layer “S2” has a humidity of between 1.2% and 2.5%, preferably equal to 1.7%.

According to one aspect of this invention, in order to optimize drying of the continuous layer “S1”, it is possible to set the length of the drying path by using a predetermined number of dryers 401, 402. The use of multiple dryers in series allows optimization of control of the process conditions (temperatures, humidity) of the step of drying.

Moreover, in order to optimize drying of the continuous layer, the dryers 401, 402 may have the same temperature profile or respective temperature profiles which are different from each other.

As a whole, the continuous layer “S1” is fed through the one or more drying spaces “V1”, “V2” for a drying time set depending on a plurality of operating parameters, such as the starting material “M1”, the thickness of the continuous layer “S1”, the temperature profile of each dryer 401, 402 and the predetermined humidity value of the dry continuous layer “S2”, as will be more apparent in the description below.

Preferably, the continuous layer “S1” is fed through the one or more drying spaces “V1”, “V2” for a drying time of between 2 minutes and 12 minutes.

As shown in FIG. 1, the plant 1 comprises a first dryer 401, defining a first drying space “V1”, and a second dryer 402, defining a second drying space “V2”.

Structurally, each dryer 401, 402 has upper drying means 401a, 402a and lower drying means 401b, 402b. Preferably, the upper drying means 401a, 402a comprise nozzles for supplying air whilst the lower drying means 401b, 402b comprise nozzles for supplying vapour, in particular, water vapour.

The upper drying means 401a, 402a act on the top of the continuous layer “S1” whilst the lower drying means 401b, 402b act on the bottom of the conveyor belt 300 so that the continuous layer “S1” is subjected to a jet of air acting on the top of it and is subjected to heating by conduction by the conveyor belt 300 since the conveyor belt 300 is in direct contact with the jet of vapour.

Advantageously, that configuration of the drying means allows gradual heating of the continuous layer “S1” along the drying path, ensuring gradual and homogeneous drying and preventing oxidative phenomena which could make the oils naturally present in the starting material “M1” go rancid.

In particular, the jet of air has a temperature of between 95° C. and 150° C. and/or a relative humidity of between 45% and 85%.

In contrast, the jet of vapour has an operating temperature of between 100° C. and 180° C.

The drying parameter values, and in particular, the thickness of the continuous layer “S1”, the drying time and the temperature profile of the one or more dryers 401, 402 (in turn set by the operating parameters of the drying means 401a, 401b, 402a, 402b), are established relative to a speed of diffusion of the one or more liquids “L” from the inner portion of the continuous layer “S1” to the outer surfaces of the continuous layer “S1”.

Control of the parameter values ensures that the temperature on the outer surfaces of the continuous layer “S1” does not reach critical values and that the humidity of the outer surfaces of the continuous layer “S1” does not drop below 1.2%, preferably below 1.7%.

Advantageously, this prevents the formation of peroxides as catalysts responsible for the processes which make the oils naturally present in the starting material “M1” go rancid. Moreover, at the same time, this prevents the outer surfaces of the continuous layer “S1” from becoming too dry and producing a barrier to diffusion of the one or more liquids “L” from the inner portions of the continuous layer “S1” towards the outside of the continuous layer “S1”. In other words, it prevents the outer surfaces, as they dry, from blocking the evaporation and therefore the drying of the more internal portions of the continuous layer “S1”.

Advantageously, the temperature of the outer surfaces of the continuous layer “S1” (and therefore the level of humidity) is regulated thanks to the latent heat of evaporation.

In order to control the operating parameter values, the one or more dryers 401, 402 may comprise a plurality of sensors (not illustrated) for measuring the above-mentioned parameters and a control unit (not illustrated) for managing the plant 1 at least depending on the measured parameter values.

Advantageously, after drying, a dry continuous layer “S2” which is substantially odourless is obtained.

As shown in FIG. 1, disposed downstream of the one or more dryers 401, 402 there is a further grinding unit 500 (optional) configured to dry grind the dry continuous layer “S2” to obtain an odourless dry powdered product having a second particle size.

The further grinding unit 500 is configured to obtain a second particle size of between 15 microns and 200 microns, preferably between 50 microns and 140 microns.

For that purpose, the further grinding unit 500 may be specifically provided with screens or other sifting means configured to allow only particles smaller than the predetermined size to pass through them.

Preferably, the further grinding unit 500 is defined by one or more stages, in particular of the silo or hammer mill or pin mill type.

The invention achieves the preset aims overcoming the drawbacks of the prior art.

In particular, the method according to this invention allows the production process to be applied to reconstituted materials of plant origin which are different from tobacco, at the same time guaranteeing optimum quality in organoleptic terms and control of the properties of the layer obtained.

Moreover, the plant necessary for implementing that method is simplified and suitable for installations with compact dimensions.

1. A method for making a layer of reconstituted material of plant origin, comprising the following steps:
providing a first quantity of a starting product constituted by solid components at a first temperature;
dry grinding the solid components of the starting product to obtain a dry powdered product having a first particle size;
mixing the dry powdered product in a mixer with a second quantity of at least one or more mixing liquids, in particular water, having a second temperature greater than the first temperature, thereby obtaining a mix having a third temperature that is greater than or equal to an enzyme deactivation temperature of the starting material; wherein the step of mixing is carried out in such a way that the third temperature is reached in a shorter time interval than a predetermined time interval;
transferring the mix onto a conveyor belt to make a continuous layer of the mix;
drying the continuous layer by feeding the continuous layer of the mix through a drying space while the continuous layer is supportably disposed on the conveyor belt, thus obtaining a dry continuous layer.

2. The method according to claim 1, wherein the predetermined time interval is less than or equal to 15 seconds.

3. The method according to claim 1, wherein the step of mixing is continued even after reaching the third temperature so as to keep the temperature of the mix above the enzyme deactivation temperature.

4. The method according to claim 3, wherein, after reaching the third temperature, the step of mixing is continued for between 5 minutes and 25 minutes.

5. The method according to claim 1, wherein at least one deodorizing agent is added to the mix, preferably after reaching the third temperature in the step of mixing; the at least one deodorizing agent preferably comprising one or more of the following:
a vapour, in particular, water vapour;
an inert gas, in particular, carbon dioxide; and/or
an apolar solvent, in particular, hexane.

6. The method according to claim 1, wherein the first supply temperature is less than an enzyme activation temperature of the starting material, preferably the first supply temperature being substantially equal to ambient temperature and/or the second supply temperature being greater than 65° C., preferably greater than 70° C.

7. The method according to claim 1, wherein the mix has a percentage by weight of the one or more mixing liquids, in particular, water, of between 30% and 70%.

8. The method according to claim 1, comprising a step of diluting the mix with one or more dilution liquids, in particular, water, performed after the step of mixing.

9. The method according to claim 8, wherein, after the step of diluting, the mix has a percentage by weight of liquid of between 70% and 90%.

10. The method according to claim 1, wherein the first particle size is between 20 microns and 500 microns, preferably between 70 microns and 250 microns.

11. The method according to claim 1, wherein the continuous layer has a thickness of between 100 microns and 800 microns.

12. The method according to claim 1, wherein the step of drying is carried out in two or more drying stages; the continuous layer being fed through two or more drying spaces disposed in series, preferably while the continuous layer is supportably disposed on the same conveyor belt.

13. The method according to claim 1, wherein the step of drying is performed by subjecting the continuous layer to a jet of air acting on the top of the continuous layer and/or by a jet of vapour acting on the bottom of the conveyor belt.

14. The method according to claim 13, wherein the jet of air has a temperature of between 95° C. and 150° C. and/or a relative humidity of between 45% and 85%.

15. The method according to claim 13, wherein the jet of vapour has a temperature of between 100° C. and 180° C.

16. The method according to claim 1, wherein, in the step of drying, the continuous layer is fed through the one or more drying spaces for a total drying time of between 2 minutes and 12 minutes.

17. The method according to claim 1, comprising a further step of dry grinding, after the step of drying, wherein the dry continuous layer is ground preferably by a hammer mill or a pin mill, to obtain an odourless, dry powdered product having a second particle size of between 15 microns and 200 microns, the second particle size being preferably between 50 microns and 140 microns.

18. The method according to claim 1, wherein the starting material is a plant fibre product different from tobacco, in particular, straw or cellulose.

19. The method according to claim 1, wherein the starting material is rapeseed and wherein the enzyme deactivation temperature is approximately 63° C.
